(19) United States
(12) Patent Application Publication
(10) Pub. No.: US 2015/0215048 A1
(43) Pub. Date: Jul. 30, 2015

(54) Univeral Automatic Bias Control Process for Digital Transmitter

(71) Applicant: NEC Laboratories America, Inc., Princeton, NJ (US)

(72) Inventors: Shaoliang Zhang, Plainsboro, NJ (US); Fatih Yaman, Monmouth Junction, NY (US); Yue-Kai Huang, Princeton, NJ (US)

(21) Appl. No.: 14/607,067

(22) Filed: Jan. 27, 2015

Related U.S. Application Data
(60) Provisional application No. 61/932,415, filed on Jan. 28, 2014.

(51) Int. Cl. H04B 10/564; H04B 10/54; H04B 10/079

(52) U.S. Cl. CPC H04B 10/564; H04B 10/07955; H04B 10/541

(57) ABSTRACT

An automatic bias control tracking for all modulation formats in an optical modulator includes monitoring the average output optical power using a low-speed photodetector to adjust the modulator bias. Two-level DC dithering signals are applied to two DC ports individually in time to isolate the impact of the other port while adjusting the current DC bias, thus improving the accuracy and efficiency. The power monitoring of low-frequency RF power is utilized to find a quad-point, where the in-phase and quadrature are orthogonal with each other. The total output power is used as a rule when adjusting the phase bias.

### RELATED APPLICATION INFORMATION

This application claims priority to provisional application No. 61/932,415 filed Jan. 28, 2014, entitled “A universal automatic bias control algorithm for digital transmitter”, the contents thereof are incorporated herein by reference

### BACKGROUND OF THE INVENTION

The present invention relates generally to optics, and more particularly, to a universal automatic bias control process for a digital transmitter.

Optical communication plays a key role in the current backbone networks for supporting high-speed/bandwidth transport between cities and continents. As the data rates increasing from 10 Gb/s up to 100 Gb/s with analog transmitter or even 400 Gb/s per channel via digital transmitter, of importance is the optical modulator capable of generating either analog or digital signals depending on the system application. To keep the modulator working in its optimal state, a bias control circuit is necessary for adjusting the modulator bias which could drift away from original settings due to the temperature, ageing, and heating from RF signal driving. In particular, as the driving signal of optical modulators becomes arbitrary waveform because of the pre-shaped digital signals generated by the high-speed digital-to-analog converters (DAC), a universal automatic bias control (ABC) process is very critical for designing optical transmitters for cost-saving and better flexibility.

The following references are noted in the background discussion:
[1] P. S. Cho, J. B. Khurgin, and I. Shpantzer, “Closed-loop bias control of optical quadrature modulator,” IEEE Photon. Technol. Lett., vol. 18, no. 21, pp. 2209-2211, November 2006.
[2] T. Yoshida, T. Sugihara, K. Uto, H. Bessho, K. Sawada, K. Ishida, K. Shimizu, and T. Mizuochi, “A study on automatic bias control for arbitrary optical signal generation by dual-parallel Mach-Zehnder modulator,” in ECOC2010, Torino, Italy, September 2010, Paper Tu.3.A.6.
[3] Mohammad Sotoodeh, Yves Beaulieu, James Harley, and Douglas L. McGhan “Modulator Bias and Optical Power Control of Optical Complex E-Field Modulators” IEEE J. Lightw. Technol., VOL. 29, NO. 15, Aug. 1, 2011.

The authors [1] invent a simple closed-loop ABC scheme for monitoring the average output power of LN modulator and the RF power for analog signals. In the proposed scheme, the tracking of phase bias is based on the minimizing the low-frequency power due to the interaction between in-phase and quadrature components. However, the design rule is not always valid because the monitored power could also be minimized when the phase bias is to make the inphase and quadrature out of phase (180°).

To address the challenge of digital waveforms, ref [2] proposes to adjust the driver gain so as to maintain the PAPR of the digital waveforms less than 50%, thereby resolving the ambiguity of the gradient of the average optical intensity. The dynamic gain control of the RF drivers would increase cost to the optical transmitter, and the small driving voltage makes the modulator to have large insertion loss to the modulated signals. The rule of tracking phase bias cannot be applied to Nyquist-shaped signals, because the error signals do NOT exhibit zero-mean sinusoidal characteristics, as suggested in the Eq(4) of ref [2]. As a result, the tracking method would fail for phase bias in digital transmitters.

There is a proposal in [3] to simultaneously apply three dither tones at three different frequencies to the three bias ports. The issue is that multiple narrow band-pass filters are required to monitor the power of those beating frequencies, and the choice of these frequencies are too tricky and complicated to be implemented in practical. Further, the approach is subjected to the “false” condition when the phase bias is located at the out-of-phase state, similar as the first approach in this section.

All the above schemes cannot be applied to binary phase-shifted keying (BPSK) signals due to the fact that BPSK signals have the same inphase and quadrature components, thus making the phase bias C more sensitive to the bias tracking.

Accordingly, there is a need for a universal automatic bias control for digital transmitters that overcomes the limitations of prior efforts.

### BRIEF SUMMARY OF THE INVENTION

The invention is directed to a method for automatic bias control tracking for all modulation formats in a modulator, the method includes monitoring an average output optical power using a low-speed photodetector to adjust a bias of a modulator, the modulator having two inner Mach-Zehnder Modulators MZMs and one outer Mach-Zehnder Modulator MZM, each modulator having a direct current DC port for a bias that is adjustable; and providing automatic bias control tracking for the DC port biases that includes applying two-level DC dithering signals to two of the DC ports individually in time to isolate the impact of the other port while adjusting a current DC bias; utilizing power monitoring of low-frequency RF power by the modulator to find a quad-point where in-phase and quadrature are orthogonal with each other; employing total output power when adjusting phase bias to avoid out-of-phase ambiguity; using a digital filter for BPSK signals by de-correlating the in-phase and quadrature components such that automatic bias control tracking works when the signals have the same in-phase and quadrature components; and speeding up bias adjustment with an adaptive steepest descent procedure.

In a similar aspect of the invention, there is provided a non-transitory storage with instructions to enable a computer implemented method for automatic bias control tracking for all modulation formats in a modulator, the method includes monitoring an average output optical power using a low-speed photodetector to adjust a bias of a modulator, the modulator having two inner Mach-Zehnder Modulators MZMs and one outer Mach-Zehnder Modulator MZM, each modulator having a direct current DC port for a bias that is adjustable; and providing automatic bias control tracking for the DC port biases that includes applying two-level DC dithering signals to two of the DC ports individually in time to isolate the impact of the other port while adjusting a current DC bias; utilizing power monitoring of low-frequency RF power by the modulator to find a quad-point where in-phase and quadrature are orthogonal with each other; employing total output power when adjusting phase bias to avoid out-of-phase ambiguity; using a digital filter for BPSK signals by de-correlating the in-phase and quadrature components such that automatic bias control tracking works when the signals have the same in-phase and quadrature components; and speeding up bias adjustment with an adaptive steepest descent procedure.

These and other advantages of the invention will be apparent to those of ordinary skill in the art by reference to the following detailed description and the accompanying drawings.

### BRIEF DESCRIPTION OF THE DRAWINGS

FIG. 1 is a diagram of the biases of an optical IQ-modulator.

FIG. 2 is a diagram of the automatic bias control ABC process, in accordance with the invention.

FIG. 3 shows FIR filtering for binary phase shift keyed BPSK signal.

FIG. 4 shows bias tracking for quadrature phase shift key signal.

FIG. 5 shows long-term QPSK signal performance.

FIG. 6 shows key aspects of the invention.

FIG. 7 shows an exemplary computer for carrying out the ABC process.

### DETAILED DESCRIPTION

The present invention is directed to a method to wherein there is monitoring of the average output optical power using a low-speed photodetector to adjust the modulator bias. With the invention, two-level DC dithering signals are applied to the two DC ports individually in time to isolate the impact of the other ports while adjusting the current DC bias, thus improving the accuracy and efficiency. The power monitoring of low-frequency RF power is utilized to find the quad-point, where the inphase and quadrature are orthogonal with each other. To avoid the most tricky out-of-phase state due to phase bias, the total output power is also used as a rule when adjusting the phase bias. In addition, a digital filter has been introduced for BPSK signals by de-correlating the inphase and quadrature components such that the proposed ABC scheme could work well even though the signals have the same inphase and quadrature components, i.e., correlated. Lastly, an adaptive steepest descent process to speed up the bias adjustment process is introduced.

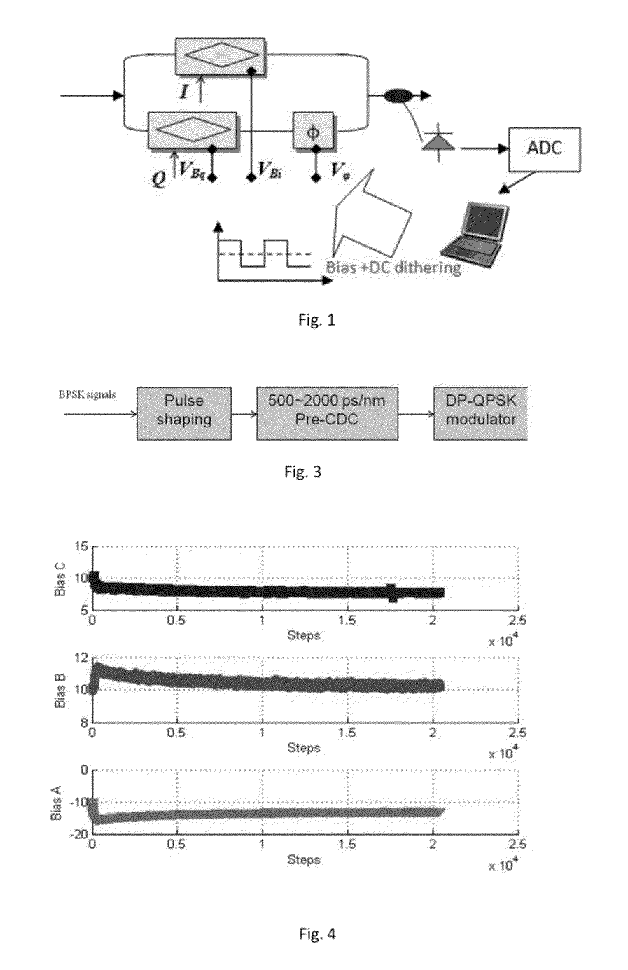

The diagram of FIG. 1 depicts the proposed ABC schematic by monitoring the optical power using a low-bandwidth photodector. An IQ-modulator consists of two inner MZMs and one outer MZM, thus having three DC biases (V_{Bi}, V_{Bq}, and V_{φ}) to adjust for appropriate operation. To generate phase-shifted keying (PSK) and quadrature amplitude modulation (QAM) formats, the two inner MZMs have to be biased at the minimum point, and the bias of the outer MZM is to generate 90° phase shift to the lower arm electric field. The output power of the modulator is tapped out and is detected by a low-bandwidth (a few hundred MHz) photodetector. The photocurrents are converted into voltages and then are digitalized in the low-speed ADC and processed by a microprocessor to check the bias status. As studied in the Ref [1], the dithering signal applied to the DC ports could be used by gradient descent process to global maximum (maximum output power of the modulator). In this invention, the dithering signal applies to the three DC ports separately in time, which facilitates the convergence of the gradient descent process could be guaranteed. However, the gradient process in our approach is to locate the global minimum rather than minimum due to the small driving voltage from DAC.

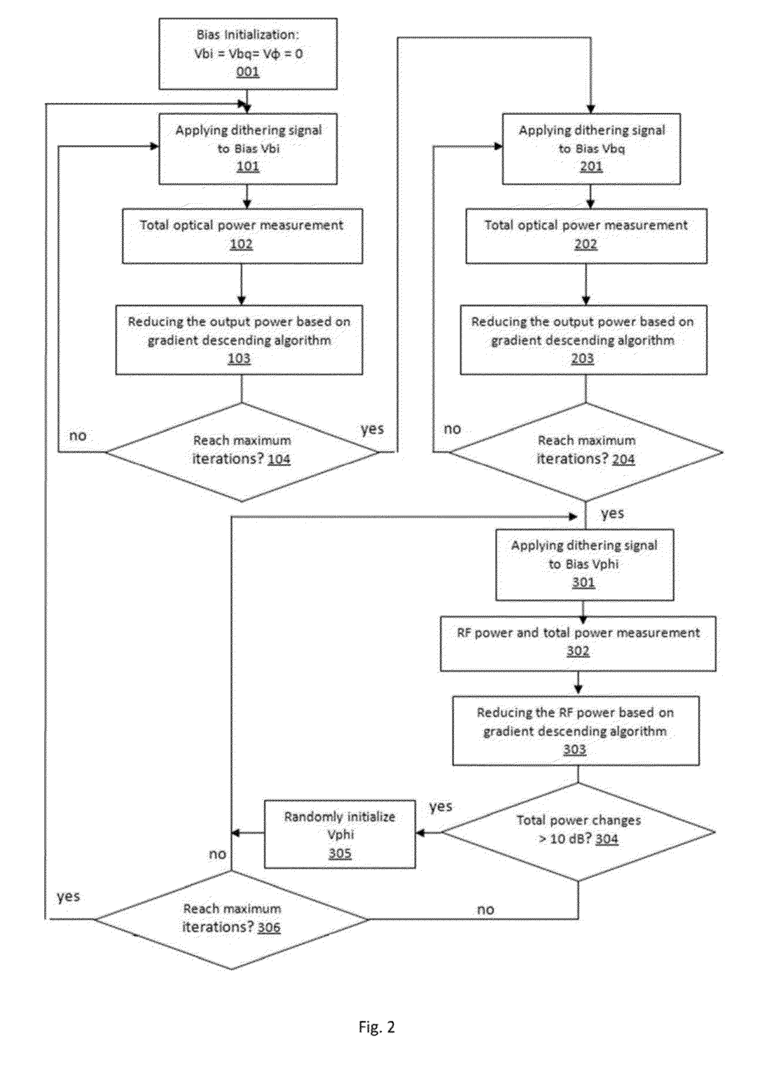

Turning now to FIG. 2, there is shown a flow diagram of the automatic control bias process, in accordance with the invention.

Block 001: The biases of modulator are initialized to 0 V.

Block 101: The bias Vbi is first selected to adjust using the proposed process. The dithering signal (−0.1 V and 0.1 V) is applied to the bias Vbi.

Block 102: Record the output power P (DC-several KHz or MHz) at both the low and high dithering bias levels: P_{low} and P_{high}.

Block 103: The bias of Vbi is updated based on the power difference between P_{low} and P_{high}, using the gradient descending process: Vbi(t+1):=Vbi(t)−α(P_{high}−P_{low}). Note that the update coefficients could be adaptively adjusted based on the following rule:

$$α = \frac{const 2}{iterations + const 1} ,$$

where the constants are empirically selected based on the photodetector response and dithering signals levels. The adaptation of the update coefficients helps the descending process quickly locate the global minimum.

Block 104: If we have already reached the iterations limits for this loop, we proceed to adjust the bias of Vbq in the Blocks 201-204 through the same process as presented here.

Block 301: After adjusting the biases of Vbi and Vbq, we now start to adjust phase bias Vphi by applying dithering signals.

Block 302: Total output power and RF power are measured for the subsequent signal processing.

Block 303: The bias of Vphi is updated based on the power difference between P_{low} and P_{high}, using the same adaptive gradient descending process: Vphi(t+1):=Vphi(t)−α(P_{high}−P_{low}).

Block 304: The total power is also monitored at both low and high dithering bias levels. If more than 5-10 dB difference has been observed, this is likely that modulator is right now at out-of-phase state.

Block 305: If the biases are detected as the out-of-phase state, the phase bias will be randomly initialized again to avoid the out-of-phase trap, where the both RF and total power are minimum.

Block 306: If we have already reached the iterations limits for this loop, we proceed to adjust the bias of Vbi in the Blocks 101-104 through the same process as presented before.

The aforementioned ABC process can be applied to any modulation formats except BPSK signal in which the inphase and quadrature components are the same. This special feature of BPSK signal would require additional effort to be carried out before using our ABC process. Here, we propose a finite-impulse-response (FIR) filter, see FIG. 3, to introduce dispersion to BPSK signals, which basically decorrelate the inphase and quadrature components. The amount of dispersion can be as low as 500 ps/nm, which requires only 9 Ts/2-FIR taps for 32 Gbaud BPSK signal.

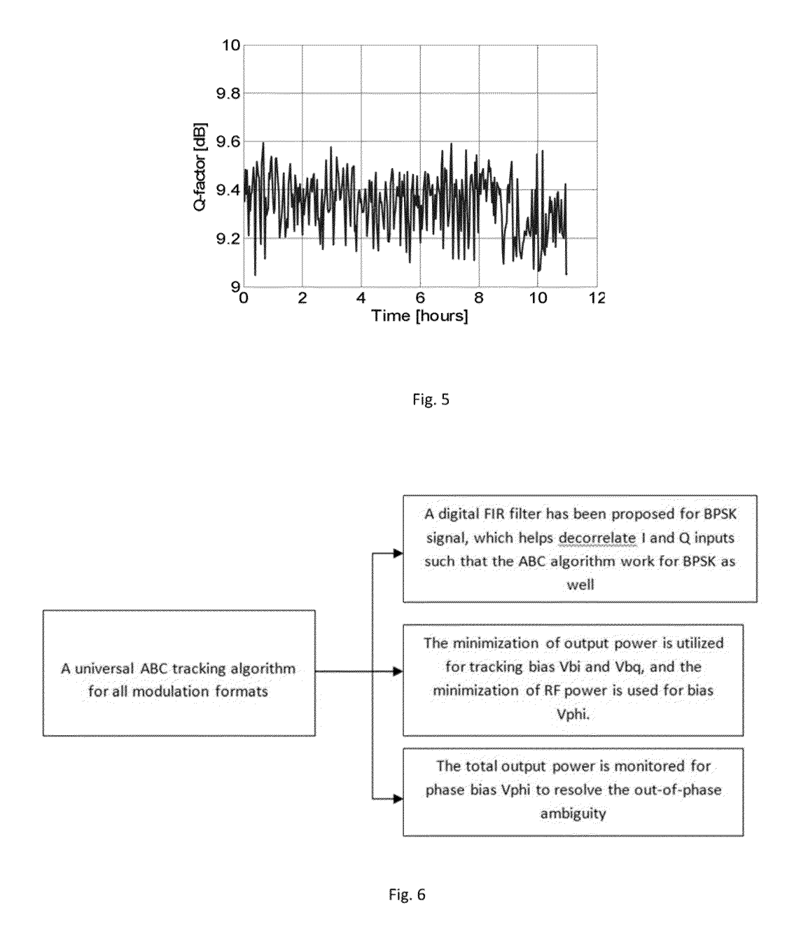

FIG. 4 shows the bias tracking of our process for 32 Gbaud QPSK signal. All three biases are set to 10 V (−10 V for bias A). After several thousand steps (the dither signal level is only −0.1 V and 0.1V, and the update coefficient is 2), the three biases approach to their optimum value. FIG. 5 plots the Q-factor performance over 11 hours, and we see a stable BTB performance by using the proposed ABC process.

Key aspects of the invention are shown in FIG. 6. The inventive universal ABC tracking process for all modulation formats includes a digital FIR filter for BPSK signal, which helps decorrelate I and Q inputs such that the ABC process works for BPSK signals as well. The inventive ABC process includes the minimization of output power that is utilized for tracking bias Vbi and Vbq, and the minimization of RF power is used for bias Vphi. The inventive ABC process includes the total output power being monitored for phase bias Vphi to resolve the out-of-phase ambiguity.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device. More details are discussed in U.S. Pat. No. 8,380,557, the content of which is incorporated by reference.

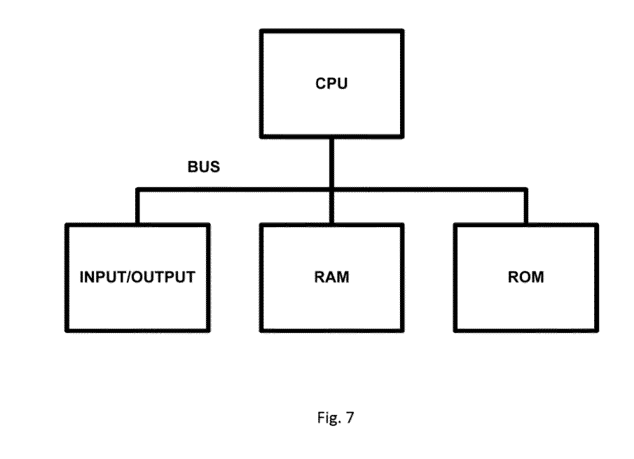

By way of example, a block diagram of a computer to support the invention is discussed next in FIG. 7. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing, it can be appreciated that with the present invention the individual DC dithering scheme helps to separate the impact of the bias drifting on the other modulators and the three-level dithering signals could well differentiate the “out-of-phase” state from the optimum points, thus making effective to any modulation formats and both analog and digital waveforms; the proposed digital filter helps ABC scheme works for any modulation formats to become a universal ABC scheme. The RF spectrum analyzer has been removed to reduce ABC cost and avoid the calibration process; the proposed adaptive steepest descent process enables to lock the bias of modulators faster. Also, the presence of FIR filtering on BPSK signal enables the proposed process to work effectively because it de-correlates the inphase and quadrature components; the total output power and RF power are simultaneously minimized to locate the optimum bias points; the total output power is monitored as a function of phase bias to address the out-of-phase issue; and the adaptive gradient descending process could facilitate the convergence of ABC tracking.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for automatic bias control tracking for all modulation formats in a modulator, the method comprising:
monitoring an average output optical power using a low-speed photodetector to adjust a bias of a modulator, the modulator having two inner Mach-Zehnder Modulators MZMs and one outer Mach-Zehnder Modulator MZM, each modulator having a direct current DC port for a bias that is adjustable; and
providing automatic bias control tracking for the DC port biases that comprises:
applying two-level DC dithering signals to two of the DC ports individually in time to isolate the impact of the other port while adjusting a current DC bias;
utilizing power monitoring of low-frequency RF power by the modulator to find a quad-point where in-phase and quadrature are orthogonal with each other;
employing total output power when adjusting phase bias to avoid out-of-phase ambiguity;
using a digital filter for BPSK signals by de-correlating the in-phase and quadrature components such that automatic bias control tracking works when the signals have the same in-phase and quadrature components; and
speeding up bias adjustment with an adaptive steepest descent procedure.

2. The method of claim 1, wherein a DC bias V_{Bias} is updated based on power differences low power P_{low} and high power P_{high} using the gradient descending of V_{Bias}(t+1):=V_{Bias}(t)−α(P_{high}−P_{low}), with
$$α = \frac{const 2}{iterations + const 1}$$
where the constants, const1 and const2 are empirically selected based on the photodetector response and dithering signals levels and adaptation of the update coefficients enables the gradient descending to locate the global minimum.

3. The method of claim 1, wherein the step of providing automatic bias control tracking comprises:
initializing first, second and third DC biases to 0;
applying a dithering signal to the first bias;
measuring total optical power;
reducing output power based on a gradient descending; and
checking is maximum iterations have been reached.

4. The method of claim 1, wherein the step of providing automatic bias control tracking comprises:
initializing first, second and third DC biases to 0;
applying a dithering signal to the first bias;
measuring total optical power;
reducing output power based on a gradient descending; and
checking is maximum iterations have been reached.

5. The method of claim 1, wherein the step of providing automatic bias control tracking comprises:
initializing first, second and third DC biases to 0;
applying a dithering signal to the third bias;
measuring RF power and total optical power;
reducing the RF power based on a gradient descending;
checking if total power changes more than a certain amount and if so the third DC bias is randomly initialized.

6. A non-transitory storage medium with instructions to enable a computer implemented method for automatic bias control tracking for all modulation formats in a modulator, the method comprising:
monitoring an average output optical power using a low-speed photodetector to adjust a bias of a modulator, the modulator having two inner Mach-Zehnder Modulators MZMs and one outer Mach-Zehnder Modulator MZM, each modulator having a direct current DC port for a bias that is adjustable; and
providing automatic bias control tracking for the DC port biases that comprises:
applying two-level DC dithering signals to two of the DC ports individually in time to isolate the impact of the other port while adjusting a current DC bias;
utilizing power monitoring of low-frequency RF power by the modulator to find a quad-point where in-phase and quadrature are orthogonal with each other;
employing total output power when adjusting phase bias to avoid out-of-phase ambiguity;
using a digital filter for BPSK signals by de-correlating the in-phase and quadrature components such that automatic bias control tracking works when the signals have the same in-phase and quadrature components; and
speeding up bias adjustment with an adaptive steepest descent procedure.

7. The non-transitory storage medium of claim 6, wherein a DC bias V_{Bias} is updated based on power differences low power P_{low} and high power P_{high} using the gradient descending of V_{Bias}(t+1):=V_{Bias}(t)−α(P_{high}−P_{low}), with
$$α = \frac{const 2}{iterations + const 1}$$
where the constants, const1 and const2 are empirically selected based on the photodetector response and dithering signals levels and adaptation of the update coefficients enables the gradient descending to locate the global minimum.

8. The non-transitory storage medium of claim 6, wherein the step of providing automatic bias control tracking comprises:
initializing first, second and third DC biases to 0;
applying a dithering signal to the first bias;
measuring total optical power;
reducing output power based on a gradient descending; and
checking is maximum iterations have been reached.

9. The non-transitory storage medium of claim 6, wherein the step of providing automatic bias control tracking comprises:
initializing first, second and third DC biases to 0;
applying a dithering signal to the first bias;
measuring total optical power;
reducing output power based on a gradient descending; and
checking is maximum iterations have been reached.

10. The non-transitory storage medium of claim 6, wherein the step of providing automatic bias control tracking comprises:
initializing first, second and third DC biases to 0;
applying a dithering signal to the third bias;
measuring RF power and total optical power;
reducing the RF power based on a gradient descending;
checking if total power changes more than a certain amount and if so the third DC bias is randomly initialized.
